(19) United States
(12) Patent Application Publication
(10) Pub. No.: US 2026/0167513 A1
(43) Pub. Date: Jun. 18, 2026

(54) METHOD AND SYSTEM FOR PRODUCTION AND APPLICATIONS OF SYNTHETIC ARAGONITE

(71) Applicant: Arelac, Inc., San Jose, CA (US)

(72) Inventors: Adriana Jacqueline Gutierrez Ramirez, Milpitas, CA (US); Sarah Granke Plata, San Jose, CA (US); Michael Kostowskyj, San Jose, CA (US); Craig W. Hargis, Colorado Springs, CO (US); Seung-Hee Kang, Campbell, CA (US); Ryan J. Gilliam, San Jose, CA (US); Miroslav Petro, San Martin, CA (US)

(21) Appl. No.: 19/416,682

(22) Filed: Dec. 11, 2025

Related U.S. Application Data
(60) Provisional application No. 63/734,514, filed on Dec. 16, 2024.

(51) Int. Cl. C01F 11/18; C04B 14/28

(52) U.S. Cl. CPC C01F 11/181; C04B 14/28; C01P 2004/03; C01P 2004/54; C01P 2004/61; C01P 2004/62

(57) ABSTRACT

Various aspects relate to production of synthetic aragonite material. In some aspects direct precipitation of aragonite, via controlling certain environmental conditions, is disclosed. In some aspects aragonite crystals may grow on seeds of other particles, such as aragonite itself, to produce long aragonite structures. In some aspect, metastable calcium carbonate such as vaterite or amorphous calcium carbonate is transformed into aragonite. In various aspects different compositions of calcium carbonate polymorphs, including aragonite, with different aspect ratios are used to produce cementitious or non-cementitious compositions with superior properties.

### CROSS-REFERENCE TO RELATED APPLICATIONS

This application claims the benefit of priority to U.S. Provisional Patent Application Ser. No. 63/734,514 entitled “Method and System for Production and Applications of Synthetic Aragonite” filed Dec. 16, 2024, the disclosure of which is incorporated herein in its entirety by reference.

### BACKGROUND

As the largest manufactured product in the world, cement production plays a substantial role in anthropogenic CO₂ emissions, contributing to approximately 7-8% of these emissions, as well as consuming over 3% of the global energy demand and emitting over 5% of global anthropogenic emissions of particles smaller than 10 micrometers.

Given the ongoing global trends of population growth and urbanization, these environmental impacts are expected to persist unless mitigation strategies are implemented. In recent years, various technical measures have emerged to mitigate these impacts. For instance, the waste CO₂ from cement kilns and fossil fuel incinerators may be harnessed through processes such as carbonation curing, secondary chemical reactions for carbon capture, or geological storage. However, these measures frequently encounter technical and economic challenges when applied in cement plants, especially in developing countries where most cement products may be produced and used.

It is therefore desirable to find alternative ways to produce low or zero carbon emission cement and other materials using or made of different polymorphs of calcium carbonate such as aragonite.

### SUMMARY

Some aspects described herein relate to a method for producing aragonite, the method including contacting carbon dioxide with a mixture including a calcium salt solution under a precipitation condition and treating the mixture to directly precipitate aragonite particles.

Some aspects described herein relate to a method, wherein the aragonite particles have an aspect ratio of at least 1.2.

Some aspects described herein relate to a method, wherein treating includes controlling precipitation conditions of the mixture, wherein precipitation conditions include at least one of temperature, pressure, and pH.

Some aspects described herein relate to a method, wherein the temperature is in a range of 30-80 degrees Celsius.

Some aspects described herein relate to a method, further including aging the mixture for a duration of time.

Some aspects described herein relate to a method, wherein precipitation conditions include a pressure different from ambient pressure.

Some aspects described herein relate to a method, further adjusting the pH of the mixture to a value different from the initial pH obtained after contacting the mixture with carbon dioxide.

Some aspects described herein relate to a method, wherein a precipitate includes aragonite particles that have a median size is in a range of 1-20 or a median size is in a range of 10-200 microns.

Some aspects described herein relate to a method, wherein a precipitate includes at least 50% aragonite.

Some aspects described herein relate to a method for growing aragonite, the method including treating the mixture with a solution including calcium ions under specific growth conditions.

Some aspects described herein relate to a method, wherein the specific growth conditions include adjusting a concentration of calcium ions to a level that is higher than a concentration related to a solubility product constant of aragonite.

Some aspects described herein relate to a method, wherein a final product of the specific growth conditions includes more than 50% aragonite.

Some aspects described herein relate to a method, wherein growth condition includes presence of at least one of magnesium, strontium, and iron.

Some aspects described herein relate to a method, wherein a final product of the specific growth conditions includes crystallites having an aspect ratio of at least 1.2.

Some aspects described herein relate to a method for producing aragonite material, the method including treating metastable calcium carbonate particles in a mixture at a specific temperature for a specified duration to transform metastable calcium carbonate to the aragonite material comprising particles agglomerated into a solid block of aragonite monolith.

Some aspects described herein relate to a method, further including adding aragonite seed to facilitate transformation of metastable calcium carbonate to the aragonite monolith.

Some aspects described herein relate to a method, wherein the metastable calcium carbonate particles include at least one of vaterite and amorphous calcium carbonate.

Some aspects described herein relate to a method, wherein specific temperature is higher than 30 degrees Celsius.

Some aspects described herein relate to a method, wherein specific duration is longer than 10 minutes.

Some aspects described herein relate to a method, wherein the mixture further includes at least one of calcium, magnesium, iron, strontium, aluminum, silicon, sulfur, nitrogen, phosphorus, chlorine, and carbon.

Some aspects described herein relate to a method, wherein the mixture includes calcium and further includes at least one of, up to 70% magnesium, up to 10% iron, and up to 5% strontium, by weight relative to calcium.

Some aspects described herein relate to a method, wherein the aragonite particles include crystals having an aspect ratio higher than 1.2.

Some aspects described herein relate to a system for producing aragonite, the system including a first reactor for contacting carbon dioxide with a mixture including calcium ions under a precipitation condition to produce metastable calcium carbonate particles; and a second reactor for treating the metastable calcium carbonate particles at a specific temperature for a specific duration to produce aragonite.

Some aspects described herein relate to a system, wherein the first reactor is connected to a calcium source including lime.

Some aspects described herein relate to a system, wherein the first reactor includes a filter configured to filter calcium.

Some aspects described herein relate to a system, wherein the first reactor is in a fluid communication with a carbon dioxide source.

Some aspects described herein relate to a system, wherein the first reactor and the second reactor are integrated.

Some aspects described herein relate to a system, wherein the first reactor and the second reactor are in fluid communication.

Some aspects described herein relate to a system, wherein the first reactor and the second reactor are kept at different pressures and different temperatures.

Some aspects described herein relate to a system, further including at least one reactor configured for at least one of purification, treatment, formulation, and packaging the aragonite.

Some aspects described herein relate to a cementitious composition including at least 0.01% of synthetic calcium carbonate particles having aspect ratio higher than 2.

Some aspects described herein relate to a cementitious composition, wherein synthetic calcium carbonate includes particles of a specific size between 0.1 micron and 500 microns.

Some aspects described herein relate to a cementitious composition, wherein synthetic calcium carbonate includes at least 0.1% of a crystalline form of aragonite.

Some aspects described herein relate to a cementitious composition, wherein the cementitious composition further includes one of a cementitious material, mineral particles, cellulose, polymeric material, silicate, aluminates, silica-aluminates, and silica.

Some aspects described herein relate to a cementitious composition, configured to change at least one of viscosity, elasticity, flexural strength, compressive strength, thermal conductivity, and permeability of a cementitious material by at least 1%.

Some aspects described herein relate to a cementitious composition that sets and hardens producing a solid block of aragonite monolith, when kept under a curing conditions comprising of a specific humidity, a specific pressure, and a specific temperature, applied during a specific time.

Some aspects described herein relate to a method of producing the solid block of aragonite monolith under the curing conditions comprising of humidity higher than 80%, pressure between 0.9 to 2 atmospheres, and temperature from 30 to 100 degrees of Celsius (° C.), for a duration longer than 24 hours.

Some aspects described herein relate to a method of producing the solid block of aragonite monolith at temperatures under 30 degrees of Celsius (° C.)

Some aspects described herein relate to a method of producing the solid block of aragonite monolith in a time shorter than 24 hours.

Some aspects described herein relate to a cementitious composition including calcium carbonate particles selected from a first group having a first combination of particle size and aspect ratio distributions and a second group having a second combination of particle size and aspect ratio distributions which is distinguished from the first combination of particle size and aspect ratio distributions.

Some aspects described herein relate to a cementitious composition, wherein the first aspect ratio is at least 2.

Some aspects described herein relate to a cementitious composition, wherein the first group includes aragonite particles.

Some aspects described herein relate to a cementitious composition, wherein the second group includes vaterite particles.

Some aspects described herein relate to a cementitious composition, wherein vaterite particles are substantially spherical.

Some aspects described herein relate to a cementitious composition, wherein calcium carbonate particles have a multimodal size distribution including at least two peaks.

Some aspects described herein relate to a method for producing aragonite particles of a specific size or shape, the method including treating solid calcium salt particles in a solution to produce aragonite particles of the specific size and shape.

Some aspects described herein relate to a method, wherein the method includes a sizing step followed by a shaping step.

Some aspects described herein relate to a method, further including using an aragonite seed for sizing or shaping.

Some aspects described herein relate to a method for producing aragonite material, the method including obtaining vaterite particles, and treating the vaterite particles in an environment including a salt solution to produce aragonite material.

Some aspects described herein relate to a method, wherein the environment includes at least one of specific range of temperature, specific range of pH, and specific range of concentration of salt in the salt solution.

Some aspects described herein relate to a method, wherein the salt solution includes a salt including at least one of calcium, magnesium, strontium, and iron.

Some aspects described herein relate to a method, wherein aragonite material is monolithic.

Some aspects described herein relate to a method, wherein the environment further includes solids.

Some aspects described herein relate to a method, wherein solids include at least one of aluminum, silicon, calcium, magnesium, iron, strontium, sulfur, nitrogen, and carbon.

Some aspects described herein relate to a method, further including at least one organic compound including at least one of small organic molecules, macromolecular compound, citric acid, acetic acid, chelating agent, and macromolecular compounds.

Some aspects described herein relate to a method for producing aragonite, the method including calcining limestone to produce a mixture including lime and a gaseous composition including carbon dioxide; contacting carbon dioxide with the mixture including lime under a precipitation condition to produce calcium carbonate particles; and, treating the calcium carbonate particles at a specific temperature for a specified duration to produce aragonite material.

Some aspects described herein relate to a method for producing calcium carbonate, the method including carbonating a calcium salt with carbon dioxide at a pressure greater than 1 atmosphere and a temperature of at least 40 degrees Celsius.

Some aspects described herein relate to a method, further including a crystallization period.

Some aspects described herein relate to a method for producing aragonite material, the method including contacting carbon dioxide with a mixture including a divalent metal ion under a precipitation condition to produce aragonite particles.

Some aspects described herein relate to a method of producing calcium carbonate cement, the method including obtaining a first component including calcium carbonate particles having a first aspect ratio distribution; obtaining a second component including calcium carbonate particles having a second aspect ratio distribution being greater than the first aspect ratio distribution; and, blending the first component and the second component in a ratio according to a required combination of performance parameters including strength, flow and set time.

Some aspects described herein relate to a method, wherein the required strength is selected from a compressive strength and a flexural strength.

Some aspects described herein relate to a method, wherein an increase of the second component is used for achieving higher flexural strength.

Some aspects described herein relate to a method, wherein an increase of the first component is used for achieving higher compressive strength.

Some aspects described herein relate to a method, wherein at least one of the first component and the second component is cementitious.

Some aspects described herein relate to a method, wherein the first component includes vaterite.

Some aspects described herein relate to a method, wherein the second component includes aragonite.

Some aspects described herein relate to a method, wherein at least one of the first component and the second component further include at least one of calcite, aragonite, vaterite, and amorphous calcium carbonate.

Some aspects described herein relate to a method for producing aragonite, the method including precipitating aragonite from a calcium salt by tuning environmental conditions for aragonite precipitation.

Some aspects described herein relate to a method, wherein environmental conditions include at least one of temperature, pressure, pH, ionic strength, and relative humidity.

Some aspects described herein relate to a method for producing aragonite, the method including obtaining calcite particles of specific size distribution; and, growing aragonite crystal on surface of calcite particles.

Some aspects described herein relate to a method, further including using a seed to promote producing aragonite.

Some aspects described herein relate to a method, further including tuning environmental conditions to promote producing aragonite.

Some aspects described herein relate to a method, wherein environmental conditions include at least one of temperature, pressure, pH, ionic strength, and relative humidity.

Some aspects described herein relate to a method, further including use of additives to promote producing aragonite.

Some aspects described herein relate to a method, wherein additives include at least one of magnesium, strontium, and iron.

Some aspects described herein relate to a method for producing aragonite using a mixture including calcite particles, wherein the calcite particles are ground limestone.

Some aspects described herein relate to a method for producing aragonite using a mixture including calcium carbonate particles, wherein calcium carbonate particles are obtained from a feedstock, and further using impurities in the feedstock to promote production of aragonite.

Some aspects described herein relate to a method, wherein feedstock includes lime kiln dust (LKD).

Some aspects described herein relate to a method, wherein feedstock includes at least one insoluble element.

Some aspects described herein relate to a method, wherein feedstock includes at least one of calcium, magnesium, iron, strontium, aluminum, silicon, sulfur, nitrogen, phosphorus, chlorine, and carbon.

### BRIEF DESCRIPTION OF THE DRAWINGS

In the accompanying figures:

FIG. 1 is an illustration of the thermodynamic states of different polymorphs of calcium carbonate according to various aspects.

FIG. 2 is a flowchart diagram of the process of direct precipitation of aragonite from a calcium salt solution according to various aspects.

FIG. 3 is an example of a scanning electron microscope (SEM) image of vaterite particles obtained in a typical precipitation process.

FIG. 4 is an illustration of controlling the ratio of different precipitated calcium carbonate polymorphs according to various aspects.

FIG. 5 is an example of an SEM image of precipitated aragonite according to some aspects.

FIG. 6 is a flowchart diagram of the process of the seeded aragonite growth according to various aspects.

FIG. 7 is an exemplary illustration of the overlapped profiles of different particle sizes according to various aspects.

FIG. 8 is an example of an SEM image showing the needle shapes of individual aragonite crystallites according to various aspects.

FIG. 9 is a flowchart diagram of transformation of metastable calcium carbonate such as vaterite to an aragonite product according to various aspects.

FIG. 10 is an example of an SEM image of an aragonite monolith.

FIG. 11 is an illustration of the dependence of the cured aragonite strength on a balance of magnesium to strontium in the starting vaterite formulation according to some aspects

FIG. 12 is an illustration of compressive strengths of aragonite monoliths prepared with different combinations of the inorganic salts.

FIG. 13 is a flowchart of aragonite manufacturing process according to the various aspects.

### DETAILED DESCRIPTION

It is to be understood that the present aspects are not limited to particular examples described, as such may, of course, vary. It is also to be understood that the terminology used herein is for the purpose of describing particular aspects only, and is not intended to be limiting.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrequited number may be a number, which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the invention, representative illustrative methods and materials are described herein.

All publications, patents, and patent applications cited in this specification are incorporated herein by reference to the same extent as if each individual publication, patent, or patent application were specifically and individually indicated to be incorporated by reference. Furthermore, each cited publication, patent, or patent application is incorporated herein by reference to disclose and describe the subject matter in connection with which the publications are cited. The citation of any publication is for its disclosure prior to the filing date and should not be construed as an admission that the invention described herein is not entitled to antedate such publication by virtue of prior invention. Further, the dates of publication provided may be different from the actual publication dates, which may need to be independently confirmed.

It is noted that, as used herein and in the appended claims, the singular forms “a”, “an”, and “the” include plural references unless the context clearly dictates otherwise. It is further noted that the claims may be drafted to exclude any optional element. As such, this statement is intended to serve as an antecedent basis for use of such exclusive terminology as “solely,” “only” and the like in connection with the recitation of claim elements, or use of a “negative” limitation.

As will be apparent to those of skill in the art upon reading this disclosure, each of the individual aspects described and illustrated herein has discrete components and features which may be readily separated from or combined with the features of any of the other several aspects without departing from the scope or spirit of the invention. Any recited method can be carried out in the order of events recited or in any other order, which is logically possible.

Calcium carbonate is one of the most abundant minerals on earth and it is found in many different forms, including the three naturally occurring crystalline polymorphs, namely calcite, aragonite, and vaterite, with their prevalence in order of decreasing thermodynamic stability. The most stable calcite prevails in nature. Metastable aragonite and vaterite are rarer and need to be synthesized to meet potential demand.

Vaterite is the most soluble polymorph, prone to transform to more stable forms. Because of its reactivity, vaterite rarely exists in nature. Synthetic vaterite has unique cementitious properties as an alternative construction material component to ordinary portland cement.

Aragonite is a metastable polymorph that may be stable for certain applications but still capable of transformations in an engineered formulation. Acicular aragonite of high aspect ratio are uniquely suited for a wide range of applications, within and beyond high-performance building materials.

Calcite constitutes the primary mineral phase in limestones and other calcareous rock formations. As the most stable and, therefore, the most common of the three polymorphs of calcium carbonate, calcite is typically the end-product of all transformations.

In various aspects, each and any of the calcium carbonate polymorphs may be produced by re-absorption and precipitation of CO₂ from industrial sources of soluble calcium. When mixed with water, the metastable CaCO₃ may undergo an additional polymorphic transformation or agglomeration and interconnection of newly formed crystallites in various aspects. Such cementitious behavior complemented by other properties enables the synthetic CaCO₃ to be used as an alternative cement material. It may also be used as a supplementary material for blended cements as well as a performance-boosting material in numerous other applications in different aspects.

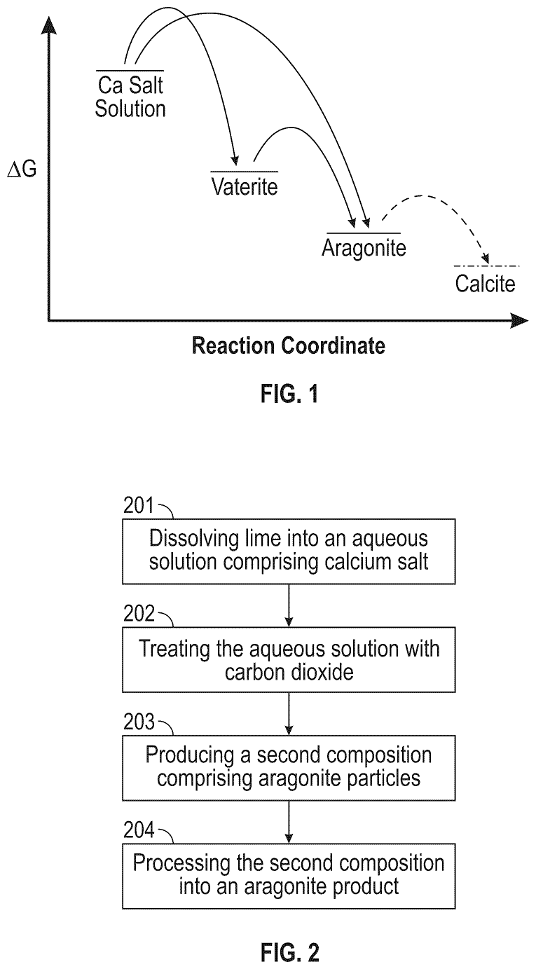

Synthetic CaCO₃ may be amorphous or may have different crystal structures. FIG. 1 is an illustration of the thermodynamic states of different polymorphs of calcium carbonate according to various aspects. Such aspects relate to methods, systems, and compositions of calcium carbonate polymorphs. As shown in the figure, thermodynamic steps of polymorphic transitions of calcium carbonate with energy minima related to different polymorphs, known as the Ostwald's rule of stages, with possible ways of producing aragonite from a calcium salt solution.

Various aspects relate to producing aragonite material via contacting carbon dioxide with a mixture including a divalent metal ion under a precipitation condition to produce metastable calcium carbonate particles under controlled conditions to produce a desired polymorph.

FIG. 2 is a flowchart diagram of the process of direct precipitation of aragonite from a calcium salt solution according to various aspects. As seen in the figure, at step 201, lime is dissolved into an aqueous solution of a first composition comprising calcium salt. At step 202, the aqueous solution is treated with carbon dioxide. This process produces a second composition consisting of aragonite particles at step 203. At step 204 the second composition is processed to produce aragonite particles.

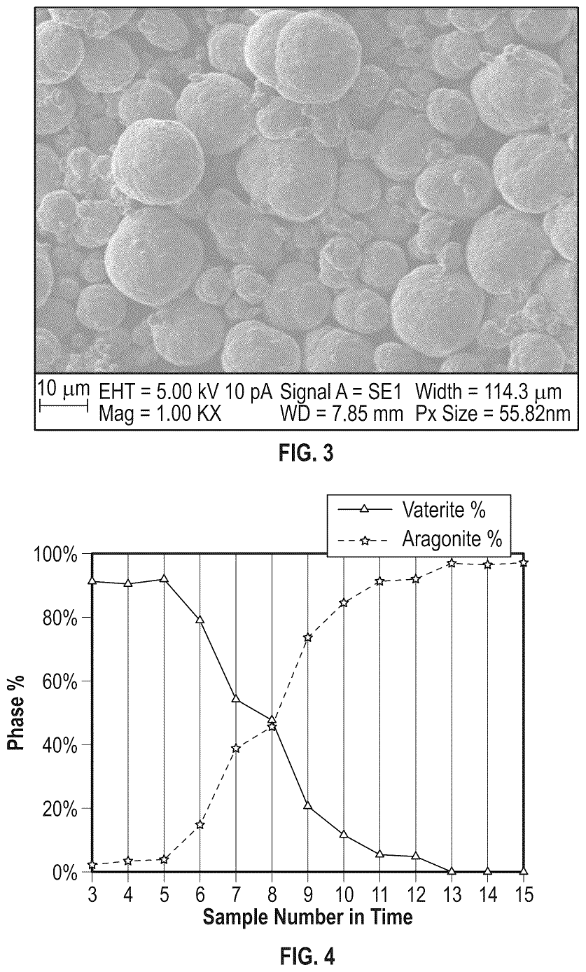

Generally, under certain conditions, which may be implemented in steps, one can precipitate calcium carbonate. The precipitate may consist of mostly vaterite under a variety of precipitation conditions. FIG. 3 is an example of a scanning electron microscope (SEM) image of vaterite particles obtained in a typical precipitation process. As may be seen from the figures, the vaterite particles are mostly significantly spherical with an aspect ratio close to 1.

Various aspects relate to directly producing aragonite through precipitation under specific precipitation conditions which promote the production of aragonite over other calcium carbonate polymorphs. The precipitation process may be controlled using various factors to obtain different polymorphic compositions of calcium carbonate. FIG. 4 is an illustration of controlling the ratio of different precipitated calcium carbonate polymorphs according to various aspects. The figure illustrates exemplary ratios of vaterite to aragonite altered upon a change in precipitation conditions according to various aspects.

In various aspects, the direct precipitation process conditions can be tuned during a production process to produce a particular polymorph. The process, according to these aspects, could be tuned for obtaining a desired polymorphic ratio of the final product as seen in the figure. The process may be subsequently altered to produce another polymorph, or alternatively changed to produce the initial polymorph by returning to the original precipitation conditions or a variation thereof in these aspects.

In various aspects, aragonite may be precipitated from calcium salt solution by controlling the environment conditions. In some precipitation schemes according to some aspects, the process includes contacting carbon dioxide with a mixture including a calcium salt solution under one or more precipitation conditions and treating the mixture to directly produce aragonite particles.

In various aspects, the mixture treatment for producing aragonite may include keeping the mixture at a specific temperature for a specified duration. In certain aspects the specific temperature is in a range of 40-100 degrees Celsius. Keeping the mixture in an environment under these temperatures promotes the production of aragonite in such aspects.

In some aspects, adjusting the precipitation conditions may include tuning the pH and temperature to promote aragonite formation. In some aspects the pH is tuned by gas flow which may be carbon dioxide. A range of acceptable pH may be 7-10. Furthermore, in some aspects, these conditions may promote further growth of aragonite crystals or their agglomeration into larger aragonite particles. Specific combinations of reaction conditions and compositions allow for control of the resulting particle size and aspect ratio.

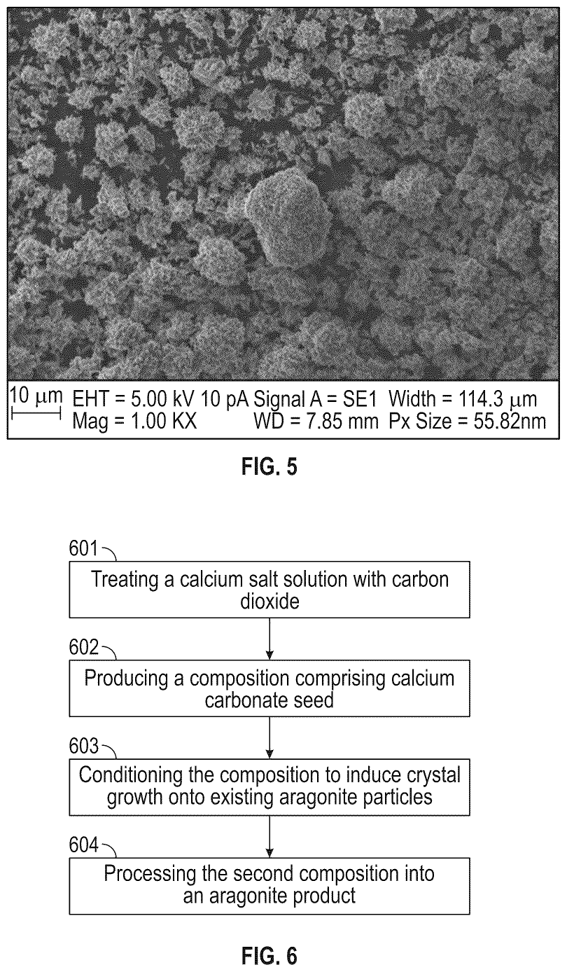

FIG. 5 is an example of an SEM image of precipitated aragonite according to some aspects. The figure further illustrates the resulting aragonite precipitate particle sizes. As seen in the figure, most particles have a size of less than 10 microns in this example. Also, as seen in the figure, most particles and crystallites have a non-spherical shape and an aspect ratio greater than 1.

Aragonite particles or aragonite crystallites, produced according to various aspects, may have an aspect ratio of at least 1.2. In some aspects the aspect ratio is at least 2. This may be compared to vaterite particles which tend to have an aspect ratio close to 1.

Various aspects relate to precipitating calcium carbonate comprising aragonite under various conditions. In some aspects, such a process includes carbonating a calcium salt with carbon dioxide at temperatures higher than 40 degrees Celsius. In some aspects, the process includes carbonating a calcium salt with carbon dioxide at specific concentrations and under a pressure greater than 1 atmosphere. In some aspects, the process includes precipitating calcium carbonate under a pressure lower than 1 atmosphere.

As an exemplary aspect, a process solution may include calcium salt and ammonium salt such as ammonium chloride. A reactor run conditions for a specific aspect may be set to values of a temperature of 50 degrees Celsius (50° C.), an impeller mixing speed of 1900 RPM, and a target value of 20% CO₂ into the reactor.

The duration needed for such a process may vary between 10-100 minutes in certain aspects. In certain aspects, however, the duration may be greater than 100 minutes.

In some aspects, the precipitation condition further includes keeping the mixture under a pressure higher than the ambient pressure. For instance, under normal conditions, the ambient pressure may be the atmospheric pressure. Accordingly, a pressure higher than 1 atmosphere may be used in these aspects.

In some aspects, during the process, the pH of the mixture is adjusted to a value different than the initial pH of carbonic acid obtained after contacting the mixture with carbon dioxide.

In addition to visualizing the aragonite crystals by scanning electron microscopy (SEM), dry aragonite was analyzed by X-ray diffraction (XRD) and particle size analysis (PSA) to quantify polymorphic purity and particle size distribution.

Aragonite particles produced according to these aspects may have a median size in a range of 1-20 microns in some aspects, whereas they may have a median size in a range of 10-200 microns in other aspects. The size and the aspect ratio of the aragonite particles are effective factors in some applications.

After the treatment, the final product includes at least 90% aragonite in some aspects. In some aspects, with more accurate specifications, the final product may be at least 98% aragonite. There may be some residual of other calcium carbonate polymorphs including vaterite and calcite, as well as some amorphous calcium carbonate depending on the circumstances.

As an example of additional processing, the aragonite precipitated in the reactor is collected, filtered, and rinsed with water. It then may optionally go into the oven for a thermal treatment.

In some aspects, aragonite made from an exemplary process solution includes at least 95% aragonite, 2-3% calcite, and about 1% vaterite. The aragonite precipitate examples may have a median particle size of 5-7 microns, and a surface area of 4-10 m²/g with a density of 2-4 g/cm³.

In some aspects, aragonite is precipitated in a process from a solution with fine particles removed. When using such a solution, the aragonite precipitate is typically larger than 10 microns, with more than 90% of the aragonite particles having a surface area between 1-4 m²/g.

In some aspects, aragonite is precipitated from dissolving lab grade calcium oxide powder using different ions in the process. This serves as a controlled lime source which does not have any of the impurities that come from the pulverized lime.

In some aspects the product composition may consist of various aspect ratio particles. In some aspects the composition may consist of at least 0.01% of aragonite particles of aspect ratio greater than 5. In some aspects, at least 1% of the aragonite particles have an aspect ratio greater than 2. In some aspects, at least 10% of the aragonite particles have an aspect ratio greater than 1.2.

In some aspects, solid material is added to the mixture. The solid material may include calcium carbonate, and in particular aragonite, to facilitate precipitation of aragonite.

In various aspects the synthetic calcium carbonate may include particles of a specific size. Different applications may require different size particles or different size distributions. By controlling certain environmental and process parameters in various aspects, calcium carbonate particles of different sizes and different aspect ratios are produced.

In some aspects, the synthetic calcium carbonate may include particles having a size between 0.1 micron and 500 microns. In some aspects, the median size of the aragonite particles is in the range of 1-30 microns.

In some aspects, the synthetic calcium carbonate product may be in a crystalline form of one of the polymorphs, or it may be a combination of aragonite, calcite, and vaterite. The ratio of each one of these components may be engineered in these aspects to provide an optimum combination of polymorphs having specific benefits for particular applications in such aspects.

Various aspects relate to crystallization growth to enlarge particle size and aspect ratio of synthetic calcium carbonate, and in particular aragonite particles. Various aspects relate to growing acicular calcium carbonate particles from calcium salt. Some aspects relate to growing acicular calcium carbonate particles using a seed.

FIG. 6 is a flowchart diagram of the process of the seeded aragonite growth according to various aspects. At step 601, calcium salt solution of a first composition is treated with carbon dioxide which produces a second composition containing calcium carbonate seeds, and in particular, aragonite seeds at step 602. At step 603, the second composition is conditioned to induce and promote a crystal growth onto existing calcium carbonate particles.

In some aspects, the existing calcium carbonate particles may consist of aragonite particles of lower aspect ratio to begin with. In some aspects, the existing calcium carbonate particles may be ground limestone.

At step 604, the final composition is processed into aragonite products. The aragonite products may be aragonite particles having larger aspect ratios. The final products may be used for a variety of applications as will be discussed below.

In some aspects the seed may include aragonite seed particles. In these aspects, the seed is of smaller particle sizes than the final aragonite particle product. Accordingly, these aspects may be used to produce aragonite particles of higher aspect ratio for specific applications requiring related performance characteristics such as higher compressive or flexural strength materials.

In various aspects, an intermediary product in the process may be metastable calcium carbonate particles including vaterite and amorphous calcium carbonate or a combination of the two. The processes of these aspects, further includes adding a seed to grow aragonite particles onto the vaterite or the amorphous calcium carbonate. In various aspects, the seed may include aragonite particles.

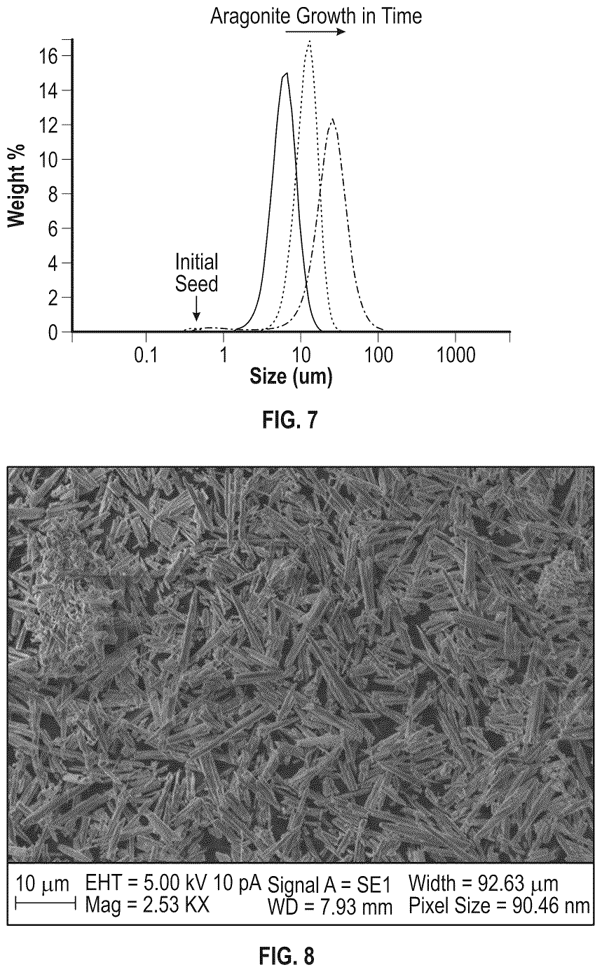

In some aspects, a precipitated calcium carbonate slurry is collected and aged in order to produce aragonite particles of different sizes and concentration ratios. FIG. 7 is an exemplary illustration of the overlapped profiles of different particle sizes according to various aspects. The figure illustrates the distributions of aragonite particle sizes under growth-promoting conditions over time according to various aspects. Upon the growth of the acicular calcium carbonate particles, the particles grow to larger size with larger aspect ratio.

In some exemplary aspects, the initial content of aragonite polymorph measured by XRD is in the range of 70% to 85%. After days of aging, the aragonite content ended up to be greater than 95% in these aspects.

In some aspects, the particle size may grow in time and, after several days without stirring, the slurry may be solidified at the bottom of a collection container. The aged aragonite crystals may have elongated acicular needle-shape of a high aspect ratio in these aspects.

FIG. 8 is an example of an SEM image showing the needle shapes of individual aragonite crystallites according to various aspects. According to these aspects, upon growing the particles, the final product has particles with acicular crystal structure. In addition, as seen in the figure, in this example, individual crystallites are elongated to aspect ratios significantly greater than 1.

In various aspects, the acicular calcium carbonate particles include aragonite. Aragonite particles or aragonite crystallites may have an aspect ratio of 1.2 or higher. This is compared to vaterite particles, for instance, which have an aspect ratio around 1, and are practically spherical in shape.

In some aspects at least 90% of the grown acicular calcium carbonate particles are aragonite. In some aspects, at least 98% of the grown acicular calcium carbonate particles are aragonite.

In some aspects, the aragonite growth follows direct calcium carbonate precipitation by tuning the solution environment and adjusting the environmental conditions to promote additional aragonite formation on precipitated particles, and to promote further growth of longer aragonite crystallites or their agglomeration into larger aragonite particles. Specific combinations of reaction conditions and composition allow for control of the resulting particle size and aspect ratio.

In some aspects, the aragonite growth is promoted by supplying additional calcium ions. To produce aragonite from the additional calcium, a composition is conditioned by controlling calcium ion concentration to be above the concentration related to the solubility constant of aragonite.

In some aspects, the additional calcium is supplied by using a metastable calcium carbonate such as vaterite with a solubility higher than that of aragonite.

Various aspects relate to producing acicular calcium carbonate particles having a specific size distribution by treating the calcium solution using a seed. The seed has a size distribution that is smaller than the specific size distribution of the produced acicular calcium carbonate. According to these aspects, creating acicular calcium carbonate particles with a larger size distribution has advantages in some applications such as those requiring improved flexural strength.

In some aspects, the aragonite particles include crystals having an aspect ratio greater than 1.2 or greater than 2. In some aspects, the aragonite particles have a median size that is larger than 1 micron. In some aspects, the aragonite particles have a median size that is larger than 10 microns.

In some aspects, temperature may be adjusted to enhance the growth of aragonite. For instance, an increase in temperature may lower the solubility of calcium carbonate and thereby promote further aragonite growth.

In some aspects, the pH may be adjusted in some aspects to enhance the growth of aragonite. For instance, an increase in pH may lower the solubility of calcium carbonate and thereby promote further aragonite growth.

In some aspects, the pH of the mixture increases by providing calcium ion alkalinity, resulting in precipitation of calcium carbonate and thereby promoting further aragonite growth.

In some aspects, certain additives may be used to enhance the growth of aragonite from seed. For instance, in some aspects, the seed including at least 50% calcium carbonate and at most 10% of one or more elements such as magnesium, strontium, and iron is used to promote the aragonite growth.

In various aspects, the seed may include any suitable solid material which promotes the growth of aragonite and having particles smaller than the aragonite product. In particular, in some aspects, the seed may be any form of calcium carbonate particles.

In various aspects the seed may be synthetic or natural aragonite. Natural aragonite is a calcareous component of marine ecosystems, serving as an essential skeleton that remains stable under specific underwater conditions. It may also be an aragonite sand on salty water beaches. Alternatively, aragonite may be formed from mineral waters, creating stable formations in some caves. The natural oolitic aragonite is used as a preferred additive in a wide range of applications from medical use, through cosmeceuticals up to construction and water industry.

In some aspects, synthetic aragonite is used as a seed. Synthetic aragonite may preserve its biocompatibility, luminescence, strength, viscoelasticity, permeability, and all other beneficial properties for numerous applications across many industries.

In some aspects, pH and temperature are tuned in a way that promotes aragonite formation, and further growth of aragonite crystals and their agglomeration into larger aragonite particles. In some aspects, specific combinations of reaction conditions and compositions are utilized for controlling the resulting particle size and aspect ratio.

In some aspects, aragonite growth is controlled by tuning the solution environment and adjusting the environmental conditions, including stirring, to achieve a desired level of aragonite growth. Specific combinations of reaction conditions and composition allow for control of the resulting particle size and aspect ratio.

In some aspects the aragonite agglomerates are broken into smaller agglomerates of particles after the growth process has been concluded. In some aspects larger agglomerates are crushed using a grinding process after washing and drying.

As was shown in FIG. 1, calcium carbonate may include several different polymorphs. Some of the polymorphs are metastable, and whereas they may be stable under certain conditions, they may otherwise react with various elements in the environment and transform into a more stable polymorph.

Various aspects relate to treating metastable calcium carbonate particles in a mixture at a specific temperature for a specified duration to produce aragonite material. In some aspects, the aragonite material may form a monolith when treated for a specific time. In some aspects, the treated aragonite material sets and hardens into a monolith of increased compressive and flexural strengths.

Various aspects relate to producing aragonite material by polymorphic transformation, including transforming less stable forms of calcium carbonate such as amorphous calcium carbonate or vaterite into more stable forms such as aragonite or calcite.

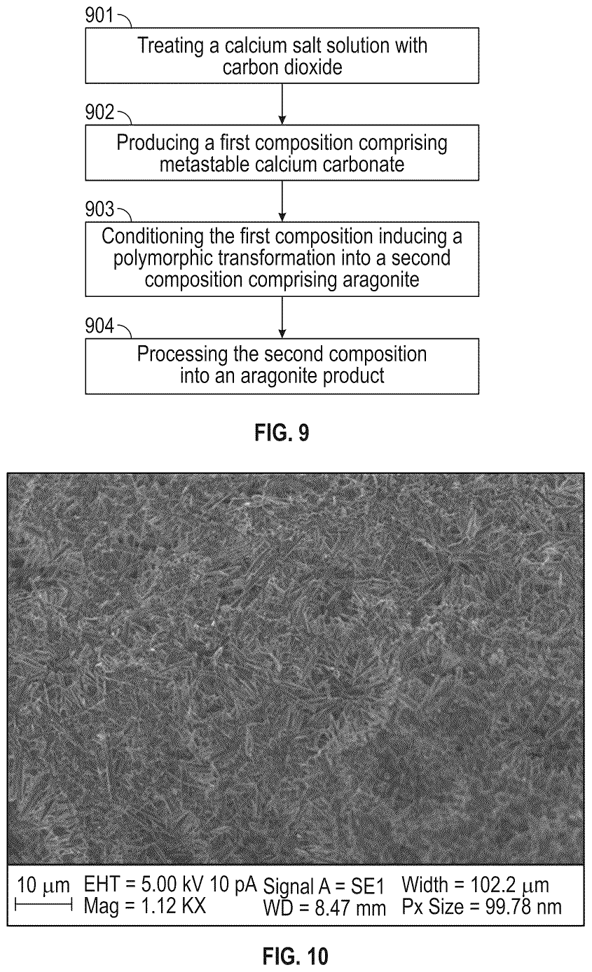

FIG. 9 is a flowchart diagram of transformation of metastable calcium carbonate such as vaterite to an aragonite product according to various aspects. At step 901, calcium salt is treated with carbon dioxide which produces a composition with metastable calcium carbonate at step 902. At step 903, the composition is conditioned to produce aragonite. Some details of the exemplary conditions that promote the production of aragonite from vaterite is given below. At step 904, the composition is turned into an aragonite product.

In some aspects, metastable calcium carbonate may be treated in a specific environment at a specific temperature for a specified duration to cause the transformation and produce aragonite particles. The aragonite particles of specific size distribution may then be stabilized as a product in some aspects. In some aspects, the product may be agglomerated or interconnected into a hardened solid block of a monolith according to different aspects.

In some aspects, pre-formed aragonite microparticles seed is used to promote the transformation of vaterite to aragonite. The formulations can be cured under a variety of conditions in different aspects to set in time and harden into a solid monolithic block with desired properties and applications.

Some aspects relate to producing aragonite material by treating vaterite particles in an environment that includes a specific salt solution. In some aspects, the salt solution is chosen from a combination of various inorganic salts dissolved in water, such as calcium chloride, magnesium nitrate, sodium phosphate, iron chloride, strontium nitrate, lithium nitrate, barium nitrate, sodium sulfate, sodium silicate, potassium aluminate, and others.

In various aspects, the produced aragonite is stable under normal conditions and may be used in a product such as building or construction material. In some aspects, the aragonite may be further transformed to calcite depending on the conditions and the application.

FIG. 10 is an example of an SEM image of the aragonite monolith. The monolith may be molded into a shape of container in which the aragonite sets and hardens. In some aspects, the solid monolithic block of aragonite is crushed and grounded into aragonite particles of various sizes.

In various aspects, the monolith may be prepared under a variety of conditions. In some aspects, vaterite cement mixtures are manipulated to produce hardened aragonite monoliths of specific porosity and mechanical properties. In some aspects the monolith is in a mixture that may include cementitious material, mineral particles, cellulose, polymeric material, silicate, aluminates, silica-aluminates, and silica, in a desired combination.

In some aspects, specific properties of the mixture may be altered by at least 1% relative to the original property such as viscosity, elasticity, compressive or flexural strength, thermal conductivity, and fluid permeability.

To achieve these goals, in some aspects, the mixture is cured at temperatures for a specific period. The duration of the curing process depends on the application and the properties and may range from 1minute to several days. The temperature may range from 0 -200 degrees Celsius.

In various aspects, specific environment conditions are used to promote production of the aragonite monolith from a mixture including metastable calcium carbonate and other calcareous solids. Such environment conditions include specific range of temperatures, specific range of pH, and specific range of concentration of salt in the salt solution.

In some aspects the mixture solution includes a salt, which may include one or more elements such as calcium, magnesium, strontium, iron, aluminum, silicon, sulfur, nitrogen phosphorus, chlorine, and carbon. Inclusion of these elements in specific ratios promotes the production of aragonite in various aspects.

In various aspects, the mixture may further include non-calcareous solids. In some aspects, the solids may include one or more elements like aluminum, silicon, magnesium, strontium, iron, sulfur, nitrogen, and carbon.

In various aspects, the mixture further includes one or more organic compounds to promote the production of aragonite. The organic compounds may include small organic molecules, citric acid, acetic acid, chelating agents, and macromolecular compounds.

In various aspects related to the production of aragonite, as a control mechanism, elemental impurities or additives may be used. These additives may include magnesium, iron, aluminum, silicon, barium, and strontium to promote the process towards producing aragonite instead of other polymorphs such as vaterite or calcite.

In various aspects, different amounts of magnesium and other elements such as strontium, sodium, iron, barium, aluminum, phosphorus, nitrogen, carbon, and sulfur may be used to promote the production of aragonite. The use of these elements may be accompanied by an optimized set of conditions, such as pH and temperature, to control the transformation of vaterite to aragonite, direct precipitation of aragonite, and further growth and agglomeration of aragonite crystals.

In some aspects, a control parameter used in the process is the level of magnesium. A specific level may be used to inhibit calcite formation and thereby promote aragonite formation. The aragonite product is stable in ordinary conditions as aragonite is the more stable crystalline polymorph of calcium carbonate when calcite formation is inhibited.

In some aspects, the required amount of magnesium and the optimized set of conditions necessary to control the transformation of vaterite to aragonite are identified and tuned, resulting in direct precipitation of aragonite, and further growth and agglomeration of aragonite crystals.

In various aspects, specific ratios of additives lead to optimal conditions for transformation of metastable calcium carbonate, such as vaterite, to aragonite. For example, in some aspects, a mixture including calcium, further includes a combination of up to 70% magnesium, up to 10% iron, and up to 5% strontium. These ratios are by weight and are relative to weight of the calcium in the mixture.

In some aspects, to facilitate the transformation to aragonite, the process may include adding seeds. Aragonite seed, in particular, may be used to promote the production of aragonite particles which have an acicular shape. The transition in various aspects is controlled by certain parameters. In some aspects a specific duration of the polymorphic transition is set to be longer than 10 minutes. In some aspects, the specific duration of the polymorphic transition is set to be shorter than 24 hours.

In some aspects the specific duration of the polymorphic transition may be accelerated by temperature. In some aspects, the specific temperature is set to higher than 30 degrees Celsius.

In some aspects, the specific duration of the polymorphic transition is set to shorter than 24 hours at a set temperature that is higher than 30 degrees Celsius.

In some aspects, the specific duration of the polymorphic transition is accelerated by specific seed material. In some aspects, the specific duration of the polymorphic transition is shorter than 24 hours using more than 1% of seed relative to metastable calcium carbonate.

Properties and performance of an aragonite monolith may be controlled according to various aspects. The performance may include many different parameters such as compressive strength which may be controlled using different additives in some aspects.

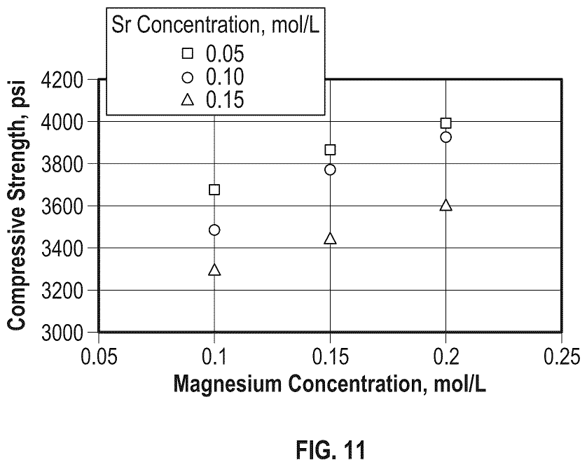

FIG. 11 is an illustration of the dependence of the cured aragonite strength on a balance of magnesium to strontium in the starting vaterite formulation according to some aspects.

In some aspects, solid blocks of aragonite monoliths are prepared from aqueous formulations containing calcium carbonate. The calcium carbonate may include vaterite in addition to up to 10 % of aragonite seed. In some aspects, various combinations of inorganic salts, containing elements such as magnesium, strontium, iron, phosphorus and others may be used in a solution. The solution may then be exposed to several different temperatures including 24, 40 and 80 ° C. for a duration of time to obtain aragonite. In some aspects, the duration is several days.

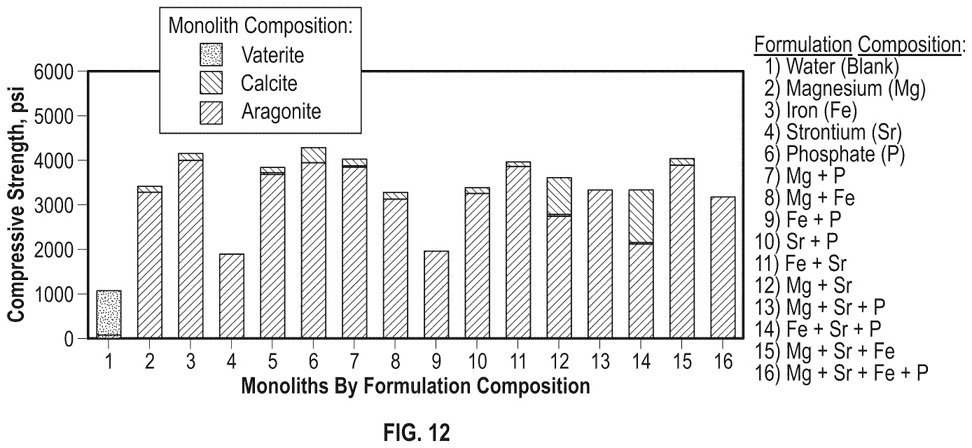

FIG. 12 is an illustration of compressive strengths of aragonite monoliths prepared with different combinations of the inorganic salts.

In some aspects the aragonite monolith is broken into smaller pieces and particles after the hardening process has been concluded. This process may include grinding after washing and drying.

Various aspects may be implemented in existing plants such as cement or concrete plants. Portland clinker is the main component of the most widely used Ordinary Portland Cement (OPC), manufactured through mining a variety of minerals such as calcite, silica, alumina and iron ore from source rock formations, such as limestone, clay, and shale.

Cement production is responsible for 7-8% of all anthropogenic CO₂ emissions, over 3% of global energy demand, and over 5% of global anthropogenic emissions of particles with a diameter of 10 micrometers or less (PM₁₀). With the megatrends of increasing global population and urbanization, these environmental impacts will not decrease if mitigation applications are not adopted. In recent years, various technical measures were found to alleviate these impacts. For example, the CO₂ in the waste gas from the cement kiln and fossil fuels incinerator can be collected for carbonation curing, secondary chemical reactions for carbon capture, geological storage, etc. But these measures often have technical and economic challenges for application in cement plants.

Calcium carbonate is a key ingredient in cement. In addition, calcium carbonate binds CO₂ with approximately 44% of its mass. Accordingly, calcium carbonate cement significantly lowers the carbon footprint relative to traditional cement formulations.

In cement production, the raw mineral materials include calcite-rich limestone, which is usually crushed, ground, and proportioned to make a feed for a kiln. In the kiln, the feed is traditionally heated typically up to 1450° C. to form a cementitious material called portland clinker.

Production of calcium compounds by calcining limestone may be carried out using various types of kilns, such as, but not limited to, a shaft kiln, a rotary kiln, an electric kiln etc. in different aspects. These apparatuses for calcining are suitable for calcining limestone in the form of lumps having diameters of several to tens millimeters.

Cement plant waste streams include waste streams from both wet process and dry process plants, which may employ shaft kilns or rotary kilns, and may include pre-calciners. These industrial plants may each burn a single fuel, or may burn two or more fuels sequentially or simultaneously.

Traditionally, limestone obtained from a limestone quarry is subjected to calcination in a cement plant resulting in the formation of calcium compounds such as calcium oxide, calcium hydroxide, or combination thereof, and CO₂ gas. Residual calcium carbonate may also be present as an outcome of incomplete or partial calcination.

The calcium compound may be calcium oxide in the form of a solid from dry kilns or cement processes or may be a combination of calcium oxide and calcium hydroxide in the form of slurry in wet kilns or cement processes.

The calcium oxide is also known as a base anhydride that converts to its hydroxide form when contacted with water liquid or vapor. Therefore, when wet, the calcium oxide may be present in its hydrated form such as calcium hydroxide. While calcium hydroxide (also called slaked lime) is a common hydrated form of calcium oxide, other intermediate hydrated and/or water complexes may also be present in the slurry, and they are all included within the scope of the present aspects.

The metastable calcium carbonate may be generated from CO₂ generated at cement kilns under strictly controlled reaction conditions. In the ReCarb® process (ReCarb® is the registered trademark of Fortera Inc.), lime is solubilized and re-carbonated by CO₂, thereby producing a polymorphic composition of calcium carbonate. The material output of the process can then be formulated into a calcium carbonate cement.

In various aspects, calcium carbonate cement manufacturing processes may utilize any of many types of limestone with various impurities. High calcium or high purity limestones may be utilized to make lime and calcium carbonate cement of high purity to manufacture high-performance materials for specific applications.

Magnesium is among the impurities coming from the raw mineral sources that affect the calcium carbonate formation process. In some aspects, the mineral feedstock comprises about 1-70% by weight of magnesium.

A magnesium bearing mineral may be mixed with limestone before calcination with the magnesium bearing mineral comprising between about 1-70% magnesium. In some aspects, upon calcination, the magnesium forms magnesium oxide. In some aspects, the magnesium bearing mineral may contain magnesium carbonate, magnesium salt, magnesium hydroxide, magnesium silicate, magnesium sulfate, or combinations thereof. In some aspects, the magnesium bearing mineral may include, without limitation, dolomite, magnesite, brucite, carnallite, talc, olivine, artinite, hydromagnesite, dypingite, barringonite, nesquehonite, lansfordite, kieserite, or a combination thereof.

Limestones that contain impurities can be first made into lime. The insoluble lime impurities may then be removed from the process solution via filtration, sedimentation, or other separation process. During the calcination of magnesium bearing limestones, such as magnesian limestone, dolomitic limestone, or dolomite, magnesium oxide is formed and can be separated from the process solution. Silica rich lime deriving from the calcination of silica rich limestones, such as sandy limestone, cherty limestone, or siliceous limestone, may have the lime solubilized in the ReCarb process and the silica impurities filtered off. Alternatively, the impurities could be finely divided by milling or grinding and then allowed to pass through the ReCarb process unchanged.

Clay bearing limestones, such as argillaceous limestone or marl, may provide additional benefits to ReAct™ blend. During the calcination of the clay bearing limestone, the clay loses water, making it more easily dissolve and become more reactive in hydraulic cements systems. In other words, the clay fraction becomes more pozzolanic. Consequently, clay bearing limestones can be used to make ReAct™ blend that contains both a carbonate and pozzolanic component.

Vaterite is the main outcome of the ReCarb® process, engineered into spherical microparticles forming a cementitious powder formulation that hardens into aragonite or calcite when mixed with water.

The ReCarb® process can be modified or appended to produce aragonite or calcite particles of pre-designed size and shape.

Various aspects relate to producing aragonite from raw mineral feedstocks. The process may start with calcining limestone to produce a mixture including lime and a gaseous composition including carbon dioxide. Subsequently, the carbon dioxide is contacted with the mixture including lime under a precipitation condition to produce calcium carbonate particles. The calcium carbonate particles are then treated at a specific temperature for a specified duration to produce aragonite cement.

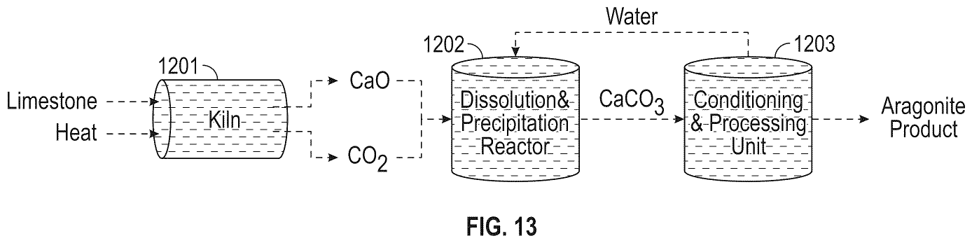

In various aspects, the aragonite production may be scaled up using a manufacturing process that includes conversion of raw limestone mineral into a soluble source of calcium, and recombination of the released CO₂ with the soluble calcium into the calcium carbonate products. FIG. 13 is a flowchart of aragonite manufacturing process according to the various aspects. As seen in the figure, limestone and heat are input into kiln 1201 where the limestone is calcinated with the heat. The heat may be direct or indirect in different aspects. The output of this process is lime and carbon dioxide, which are input into dissolution and precipitation reactor 1202. The output of this process is calcium carbonate which is input into conditioning and processing unit 1203. After processing the final product is aragonite as seen in the figure.

Some aspects relate to a system for producing aragonite material. The system includes a first reactor for contacting carbon dioxide with the mixture including calcium ions under a precipitation condition to produce metastable calcium carbonate particles. The system further includes a second reactor for treating the metastable calcium carbonate particles at a specific temperature for a specified duration to produce aragonite material.

In some aspects, the first reactor is connected to a calcium source which includes lime.

In some aspects the first reactor includes a filter configured to filter the calcium source. In some aspects the first reactor is in a fluid communication with a carbon dioxide source.

In some aspects relate to wherein the first reactor and the second reactors are integrated. In these aspects, a single reactor may perform both functions accordingly.

Some aspects relate to wherein the first reactor and the second reactors are in fluid communication

In some aspects the system is kept at a pressure which is different from the ambient pressure. The value of the pressure of the system is chosen to promote the production of aragonite.

In some aspects the heating reactor is connected to additional units which perform functions such as purification, treatment, formulation, and packaging of the aragonite material product.

In various aspects, the cement product includes vaterite and aragonite. Vaterite particles have a circular shape which makes for great workability, water reduction, and efficient packing giving rise to a high compressive strength. In such a blend, the vaterite particles, being substantially spherical, serve to give the cement formulation added flowability and moldability before hardening.

In various aspects, acicular particles, such as the elongated aragonite crystals can act as a mineral reinforcement fiber affecting ductility and viscoelasticity of composite materials. In addition to contributing to compressive strength, the fiber significantly improves flexural strength of the resulting composites in these aspects.

In some aspects, the cement product includes vaterite, aragonite, and other calcareous material such as calcite.

In some aspects, the cement product includes vaterite, aragonite, calcite, and other non-calcareous material such as silica sand or cement clinker.

Some aspects relate to specific blends of non-acicular and acicular particles. Such compositions are suitable for applications where the benefits of higher aspect ratio of acicular aragonite are balanced by the cementitious and flow properties of spherical vaterite. The two components provide complementary properties which give rise to various benefits in these aspects.

In some aspects, elongated aragonite crystals are engineered and used to act as a mineral reinforcement fiber in specific cementitious composites. These composites may include fiber-cement, fiber-mat, polymer blends and fiber-reinforced products. Fiber reinforcements make cementitious composites stronger and more flexible, ductile, and tough. The reinforced composite material may maintain desired properties while decreasing the content of cement and thereby decrease the need for supplementary cementitious materials and crosslinkers. Such composite products have superior properties accordingly.

Various aspects relate to a cement product with improved flexural strength. In some aspects, a composition of matter includes at least two different types of calcium carbonate particles. These two different components may be vaterite and aragonite.

In some aspects, the ratio of vaterite and aragonite varies depending on the need for cementitious activity versus final strength and ductility requirements. In various aspects about 5 to 50% of aragonite is used in combination with vaterite for the cement formulations.

Some aspects relate to a cementitious composition including calcium carbonate particles selected from a first group having a first aspect ratio and a second group having a second aspect ratio which is distinguished from the first aspect ratio. The distribution of the different aspect ratios in these aspects may have distinguished peaks or distinguished medians.

In some aspects, the larger aspect ratio of the two components is at least 2. This larger aspect ratio may relate to aragonite particles in various aspects.

In some aspects the second group, which has lower aspect ratio, includes vaterite particles. The vaterite particles are substantially spherical. Additionally, in some aspects, the vaterite particles have two distinguished size distributions themselves, which may include two peaks or medians. These aspects may be used for improved packing, and subsequently, improved compressive strength.

In some aspects, the synthetic calcium carbonate particles are formulated with natural calcium carbonate, sand, cement clinker, and other particulate materials, into a complex mixture.

In various aspects, formulating particles of different crystalline forms, including aragonite, calcite and vaterite, of different particle sizes, and of different aspect ratios, may create densely packed structures of improved viscoelasticity of aqueous formulations and mechanical properties of hardened solids.

In some aspects, the size of the synthetic calcium carbonate particles is engineered to complement particles which are already in the formulation mixture. For instance, higher aspect ratio particles may be engineered for applications in such aspects that require ductility and high flexural strength. On the other hand, when the formulation mixture needs to flow and be molded, lower aspect ratio particles may be engineered. Finally, when both sufficient flow and high compressive and flexural strengths are required, a combination of higher and lower aspect ratio particles may be engineered.

The elongated aragonite crystals may also affect permeability of a composite material. for example, this may serve as a filter aid to remove undesired particulates from a fluid stream flowing in between the crystals. A variety of the aragonite-based separation media can be prepared in combination with support materials such as sand and fabric. and natural or organic polymers. In various aspects, properties of engineered aragonite particles, such as size distribution, shape, and aspect ratio, allow users to control the pore-size distribution of the composite and related selectivity and flow properties of the aragonite-based separation medium as well as the efficiency of the separation process.

Although the foregoing aspects have been described in some detail by way of illustration and example for purposes of clarity of understanding, it should be readily apparent to those of ordinary skill in the art in light of the teachings of these aspects that certain changes and modifications may be made thereto without departing from the spirit or scope of the appended claims. Accordingly, the preceding merely illustrates the principles of the present aspects.

It will be appreciated that those skilled in the art will be able to devise various arrangements, which, although not explicitly described or shown herein, embody the principles of the present aspects, and are included within its spirit and scope. Furthermore, all examples and conditional language recited herein are principally intended to aid the reader in understanding the principles of the present aspects and the concepts contributed by the inventors to furthering the art, and are to be construed as being without limitation to such specifically recited examples and conditions.

Moreover, all statements herein reciting principles, aspects, and the present aspects as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

The scope of the present aspects, therefore, is not intended to be limited to the examples shown and described herein. It is intended that the following claims define the scope of the present aspects and that processes and structures within the scope of these claims and their equivalents be covered thereby.

1. A method for producing aragonite, the method comprising:
contacting carbon dioxide with a mixture comprising a calcium salt solution under a precipitation condition and treating the mixture to directly precipitate aragonite particles, wherein the precipitation condition comprises adjusting at least one of temperature, pressure, and pH.

2. The method of claim 1, wherein the aragonite particles have an aspect ratio of at least 1.2.

3. The method of claim 1, further comprising aging the mixture for a duration of time.

4. The method of claim 1, wherein precipitation conditions comprises a pressure different from ambient pressure.

5. The method of claim 1, further adjusting the pH of the mixture to a value different from an initial pH obtained after contacting the mixture with carbon dioxide.

6. The method of claim 1, wherein a precipitate comprises aragonite particles that have a median length of 1-200 microns.

7. A method for growing aragonite, the method comprising treating an aragonite base with a solution comprising calcium ions under specific growth conditions by adjusting a concentration of calcium ions to a level that is higher than a concentration related to a solubility product constant of aragonite.

8. The method of claim 7, wherein the specific growth conditions comprise adjusting a concentration of calcium ions to a level that is higher than a concentration related to a solubility product constant of aragonite.

9. A method for producing aragonite monolith, the method comprising treating metastable calcium carbonate particles in a mixture at a specific temperature for a specified duration to transform metastable calcium carbonate to aragonite monolith.

10. The method of claim 9, wherein a final product comprises more than 50% aragonite.

11. The method of claim 9, further comprising adding aragonite seed to facilitate transformation of metastable calcium carbonate to aragonite monolith.

12. The method of claim 9, wherein the metastable calcium carbonate particles comprise at least one of vaterite and amorphous calcium carbonate.

13. The method of claim 9, wherein specific temperature is higher than 30 degrees Celsius and specific duration is longer than 24 hours.

14. The method of claim 9, wherein the mixture comprises calcium and further comprises at least one of, up to 70% magnesium, up to 10% iron, and up to 5% strontium, by weight relative to calcium.

15. A cementitious composition comprising at least 0.01% of synthetic calcium carbonate particles having aspect ratio higher than 2.

16. The cementitious composition of claim 15, wherein synthetic calcium carbonate comprises particles of a specific size between 0.1 micron and 500 microns.

17. The cementitious composition of claim 15, wherein synthetic calcium carbonate comprises at least 0.1% of a crystalline form of aragonite.

18. A method for reinforcing a construction material, the method comprising adding aragonite particles with a specific aspect ratio as a mineral fiber to reinforce the construction material.

19. The method of 18, wherein the specific aspect ratio of aragonite particle is greater than 2.

20. The method of 18, wherein the construction material comprises at least one of hydraulic cement, concrete, and vaterite.
